(19) United States
(12) Patent Application Publication
(10) Pub. No.: US 2019/0228478 A1
(43) Pub. Date: Jul. 25, 2019

(54) METHOD FOR PREDICTING FISHING ACCESS OF KATSUWONUSPELAMIS PURSE SEINE FISHERY IN THE CENTRAL AND WESTERN PACIFIC

(71) Applicant: Shanghai Ocean Univeristy, Shanghai (CN)

(72) Inventors: Xinjun CHEN, Shanghai (CN); Yangyang CHEN, Shanghai (CN); Jintao WANG, Shanghai (CN); Lin LEI, Shanghai (CN)

(73) Assignee: Shanghai Ocean Univeristy, Shanghai (CN)

(21) Appl. No.: 16/313,134

(22) PCT Filed: Dec. 22, 2017
(86) PCT No.: PCT/CN2017/118073

§ 371 Date: Dec. 25, 2018

(30) Foreign Application Priority Data
Dec. 26, 2016 (CN) 201611215669.8

(51) Int. Cl. G06Q 50/02; G06Q 10/06; G06Q 10/04; G06N 5/04

(52) U.S. Cl. CPC G06Q 50/02; G06Q 10/06315; G06F 17/18; G06N 5/04; G06Q 10/04

(57) ABSTRACT

A method for predicting fishing access of Katsuwonuspelamis purse seine fishery in the Central and Western Pacific adopts the statistical data per year before the forecast year to the previous 16 years, including year, month, longitude, latitude, fishing effort (the number of nets) and the catch (ton) in an important operation waters of 5°S-5°N, 125°E-180°E, a sea surface temperature anomaly (SSTA) in the Nino3.4 area and the sea surface temperature (SST) in the operation waters. A sea area is denoted by 5°×5° spatial resolution, the production statistical data of the sea areas are matched with the corresponding environmental data one by one to obtain the relationship between different SSTA and SST ranges of each sea area and the corresponding initial value fishing effort, a fishing access prediction model of each sea area is established by using a normal distribution model.

### CROSS REFERENCE TO THE RELATED APPLICATIONS

This application is the national phase entry of International Application No. PCT/CN2017/118073, filed on Dec. 22, 2017, which is based upon and claims priority to Chinese Patent Application No. 201611215669.8, filed on Dec. 26, 2016, the entire contents of which are incorporated herein by reference.

### TECHNICAL FIELD

The present invention relates to a method for predicting fishing access of Katsuwonuspelamis purse seine fishery in the Central and Western Pacific.

### BACKGROUND

Katsuwonuspelamis plays an extremely important role in the worldwide tuna fishery, and the Central and Western Pacific is important operation waters. In recent years, the average annual production of Katsuwonuspelamis in the Central and Western Pacific has exceeded 1.5 million tons, which accounts for 60% of the worldwide Katsuwonuspelamis yield. Studies show that the El Niño/La Niña event is closely related to the distribution of fishing grounds of Katsuwonuspelamis resources in the Central and Western Pacific, and the changes in climate and marine environment lead to the changes in the spatial distribution of the Katsuwonuspelamis resources. There are 12 countries and regions in the Central and Western Pacific waters, only a small part of which are international waters, and the Katsuwonuspelamis is distributed in the jurisdictional waters of the 12 countries and regions and the international waters. Tuna purse seiners in China usually enter the waters of other countries for fishing through the purchase of permits, and the permit operations are purchased on a daily basis. At present, there are 24 tuna purse seiners in China in total with an annual output of 100-150 thousand tons. However, due to the annual and seasonal changes in the Katsuwonuspelamis fishing grounds, and the increase of the fishing access of the South Pacific island countries, the development of the tuna purse seine fishery in China faces some serious problems: (1) the medium and long-term tuna resources and spatial distribution are unpredictable, resulting in the increase of blindness in the purchase of fishing access countries and catch quotas, thus affecting the overall benefits of tuna purse seine fishery; and (2) the operation days are limited in the South Pacific island countries, the management is becoming stricter, and the fishing access cost is also continuously increased, resulting in relatively low operation efficiency and economic benefits. In view of this, it is necessary to establish a high-precision method for predicting fishing access of Katsuwonuspelamis purse seine fishery in the Central and Western Pacific so as to provide a basis for the scientific fishing access of the tuna purse seine fishery.

### SUMMARY

The object of the present invention is to establish a prediction model of fishing access of Katsuwonuspelamis purse seine fishery in important operation waters (the area is 5°S-5°N, 125°E-180°E) in the Central and Western Pacific based on fishing effort, in order to provide a basis for the scientific fishing access of the tuna purse seine fishery, the purchase of fishing operation permit and the purchase of number of days of fishing access.

The technical solution of the present invention adopts statistical data per year before the forecast year to the previous 16 years, including year, month, longitude, latitude, fishing effort (in the number of nets) and the catch (in ton) in important operation waters of 5°S-5°N, 125°E-180°E, a sea surface temperature anomaly (expressed by SSTA) in the Nino3.4 area and the sea surface temperature (expressed by SST) in the operation waters, wherein a sea area is denoted by 5°×5° spatial resolution, the production statistical data of the sea areas in the previous 16 years are matched with the corresponding environmental data one by one to obtain the relationship between different SSTA and SST ranges of each sea area and the corresponding initial value fishing effort, an fishing access prediction model of each sea area is established by using a normal distribution model, and the fishing access prediction model is expressed by a percentage of the fishing effort; the fishing effort is used for characterizing a central fishing ground by using the number of n the initial value processing of the fishing effort is to calculate a percentage

$${N}_{i , j} = \frac{{X}_{i , j}}{{X}_{j}}$$

occupied by different SSTA ranges of the Nino3.4 area corresponding to each sea area by using a spacing 0.5° C. of the SSTA of the Nino3.4 area and the SST of the operation waters, and then divide the obtained percentage by the maximum ratio in the sea area to obtain

$$\overline{{N}_{i , j}} = \frac{{N}_{i , j}}{max {N}_{i , j}} ,$$

wherein Xⱼ represents the total amount of fishing effort in the j sea area, X_{i,j} represents the fishing effort within the i temperature range in the j sea area, N_{i,j} represents the percentage of the fishing effort within the i temperature range in the j sea area; maxN_{i,j} represents the maximum value of the percentage of the fishing effort within the i temperature range in the j sea area; and N̅_̅{̅i̅,̅j̅}̅ represents the ratio of the percentage of the fishing effort within the i temperature range in the j sea area to the maximum value of the percentage.

The present invention is based on the production data of the Katsuwonuspelamis purse seine fishery in the Central and Western Pacific per year before the forecast year to the previous 16 years, the change law of the fishing effort on the spatial distribution is adopted, meanwhile, the relationship between the fishing effort and the SSTA of the Nino 3.4 area and the operation waters is established, the spatial and temporal distribution probability of the Katsuwonuspelamis resources in different marine environments is expressed in the form of a normal model, a basis is provided for the scientific fishing access of the Katsuwonuspelamis purse seine fishery in the Central and Western Pacific, the blindness of fishing is greatly reduced, and the fishing efficiency is improved.

### BRIEF DESCRIPTION OF THE DRAWINGS

FIG. 1 is a distribution diagram of accumulative fishing efforts of sea areas at various latitudes.

FIG. 2 is a distribution diagram of percentages of fishing efforts of 22 sea areas in the Central and Western Pacific.

### DETAILED DESCRIPTION OF THE EMBODIMENTS

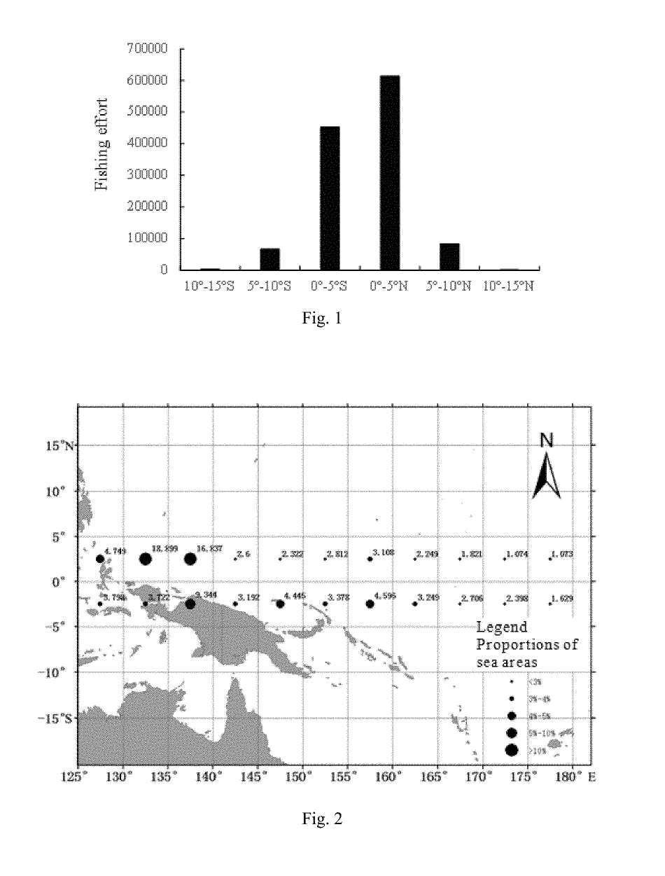

The method includes: selecting important operation waters of 15°S-15°N, 125°E-180°E, and using statistical materials from 1995 to 2012, including year, month, longitude, latitude, and fishing effort (using the number of nets as an index) and the catch (in ton), a sea surface temperature anomaly (SSTA) in the Nino3.4 area and the sea surface temperature (SST) in the operation waters, wherein the data in the 1995-2010 are used for establishing a prediction model, and the data in the 2011-2012 are applied to prediction, forecast and verification. According to each 5 degrees on the latitude direction, the cumulative fishing effort distribution situation in each sea area on the latitude direction is counted (FIG. 1), wherein 22 sea areas in total, in the 5°S-5°N, 125°E-180°E waters, are the most important operation waters, the number of nets accounts for about 87.4% of the total amount in all waters in the Central and Western Pacific, therefore the specific embodiment is illustrated by using the 22 5°×5° sea areas of the 5°S-5°N, 125°E-180°E waters as an example (FIG. 2). The fishing effort can be used as an index to characterize a central fishing ground. Therefore, the number of nets is selected to characterize the central fishing ground. Firstly, initial value processing is performed on the fishing effort to calculate a percentage

$${N}_{i , j} = \frac{{X}_{i , j}}{{X}_{j}}$$

occupied by different SSTA ranges of the Nino3.4 area corresponding to each sea area by using a spacing 0.5° C. of the SSTA of the Nino3.4 area and the SST of the operation waters, and then divide the obtained percentage by the maximum ratio in the sea area to obtain

$$\overline{{N}_{i , j}} = \frac{{N}_{i , j}}{max {N}_{i , j}} ,$$

wherein Xⱼ represents the total amount of fishing effort in the j sea area, X_{i,j} represents the fishing effort within the i temperature range in the j sea area, N_{i,j} represents the percentage of the fishing effort within the i temperature range in the j sea area; maxN_{i,j} represents the maximum value of the percentage of the fishing effort within the i temperature range in the j sea area; and N̅_̅{̅i̅,̅j̅}̅ represents the ratio of the percentage of the fishing effort within the i temperature range in the j sea area to the maximum value of the percentage. The production statistical data of the 22 sea areas within 16 years (1995-2010) are matched with the corresponding environmental data one by one, the relationship between different SSTA and SST ranges of each sea area and the corresponding initial value fishing effort is obtained, and a fishing access prediction model of each sea area is established by using a normal distribution model. The fishing access prediction model is expressed by a percentage of the fishing effort.

The established fishing access prediction model of Katsuwonuspelamis purse seine fishery in the Central and Western Pacific is verified by using the production data of 2011 and 2012, and the above two models are compared. The advantages and disadvantages of the models are compared by a correlation coefficient R² of a predicted value and an actual value. The analysis of the fishing access prediction model based on the SSTA of the Nino3.4 area shows that the initial fishing efforts of the SSTA of the Nino3.4 area and the 22 sea areas are normally distributed, and the correlation coefficients are above 0.9 (P<0.01) (Table 1), and the peaks are between −0.25° C. and 0.25° C.

TABLE 1
Fishing access prediction model based on the SSTA of the NINO 3.4 area of sea areas

| | | correlation | |
|---|---|---|---|
| | | coefficient | |
| Forecast unit | Model | R² | P value |
| 0°-5°N [symbol] 125°-130°E | Y=EXP(−0.7582 * (X_{SSTA}+0.0990)\hat{ }2) | 0.9462 | 0.0001 |
| 0°-5°N [symbol] 130°-135°E | Y=EXP(−0.7468 * (X_{SSTA}+0.1225)\hat{ }2) | 0.9492 | 0.0001 |
| 0°-5°N [symbol] 135°-140°E | Y=EXP(−0.7520 * (X_{SSTA}+0.0953)\hat{ }2) | 0.9371 | 0.0002 |
| 0°-5°N [symbol] 140°-145°E | Y=EXP(−3.5755 * (X_{SSTA}−0.2922)\hat{ }2) | 0.9647 | 0.0001 |
| 0°-5°N [symbol] 145°-150°E | Y=EXP(−4.5820 * (X_{SSTA}−0.1545)\hat{ }2) | 0.9514 | 0.0001 |
| 0°-5°N [symbol] 150°-155°E | Y=EXP(−2.5529 * (X_{SSTA}−0.0930)\hat{ }2) | 0.8879 | 0.0014 |
| 0°-5°N [symbol] 155°-160°E | Y=EXP(−1.7693 * (X_{SSTA}−0.1123)\hat{ }2) | 0.9445 | 0.0001 |
| 0°-5°N [symbol] 160°-165°E | Y=EXP(−1.3309 * (X_{SSTA}−0.0754)\hat{ }2) | 0.8963 | 0.0011 |
| 0°-5°N [symbol] 165°-170°E | Y=EXP(−2.0162 * (X_{SSTA}−0.0471)\hat{ }2) | 0.9652 | 0.0001 |
| 0°-5°N [symbol] 170°-175°E | Y=EXP(−0.7942 * (X_{SSTA}+0.0107)\hat{ }2) | 0.9542 | 0.0001 |
| 0°-5°N [symbol] 175°-180°E | Y=EXP(−2.058 * (X_{SSTA}−0.1552)\hat{ }2) | 0.97 | 0.0001 |
| 0°-5°S [symbol] 125°-130°E | Y=EXP(−0.7653 * (X_{SSTA}+0.1297)\hat{ }2) | 0.9613 | 0.0001 |
| 0°-5°S [symbol] 130°-135°E | Y=EXP(−0.7638 * (X_{SSTA}+0.1335)\hat{ }2) | 0.9599 | 0.0001 |
| 0°-5°S [symbol] 135°-140°E | Y=EXP(−0.7837 * (X_{SSTA}+0.1217)\hat{ }2) | 0.958 | 0.0001 |
| 0°-5°S [symbol] 140°-145°E | Y=EXP(−2.5445 * (X_{SSTA}−0.2220)\hat{ }2) | 0.961 | 0.0001 |
| 0°-5°S [symbol] 145°-150°E | Y=EXP(−1.6767 * (X_{SSTA}−0.0607)\hat{ }2) | 0.9624 | 0.0001 |
| 0°-5°S [symbol] 150°-155°E | Y=EXP(−1.4449 * (X_{SSTA}+0.0696)\hat{ }2) | 0.9292 | 0.0003 |
| 0°-5°S [symbol] 155°-160°E | Y=EXP(−1.0188 * (X_{SSTA}−0.0006)\hat{ }2) | 0.9708 | 0.0001 |
| 0°-5°S [symbol] 160°-165°E | Y=EXP(−0.9379 * (X_{SSTA}−0.0601)\hat{ }2) | 0.9095 | 0.0007 |
| 0°-5°S [symbol] 165°-170°E | Y=EXP(−1.0403 * (X_{SSTA}+0.0087)\hat{ }2) | 0.9713 | 0.0001 |
| 0°-5°S [symbol] 170°-175°E | Y=EXP(−1.0703 * (X_{SSTA}−0.0995)\hat{ }2) | 0.9911 | 0.0001 |
| 0°-5°S [symbol] 175°-180°E | Y=EXP(−1.2191 * (X_{SSTA}−0.1445)\hat{ }2) | 0.933 | 0.0002 |

In the table, Y represents the percentage of the number of nets, and X_{SSTA} represents a temperature interval corresponding to SSTA

The initial fishing efforts of the SST of the operation waters and the 22 sea areas are normally distributed, and the correlation coefficients are above 0.85 (P<0.01) (Table 2). The operation fishing grounds are basically distributed in the waters with SST of 27.5-30.5° C., and in the waters with peaks of 29-29.5° C.

TABLE 2
Fishing access prediction model based on the SST of the operation waters of sea areas

| | | correlation | |
|---|---|---|---|
| | | coefficient | |
| Forecast unit | Model | R² | P value |
| 0°-5°N [symbol] 125°-130°E | Y=EXP(−1.3097 * (X_{SST}−28.9562)\hat{ }2) | 0.978 | 0.0001 |
| 0°-5°N [symbol] 130°-135°E | Y=EXP(−2.3738 * (X_{SST} −29.2748)\hat{ }2) | 0.9866 | 0.0001 |
| 0°-5°N [symbol] 135°-140°E | Y=EXP(−1.9601 * (X_{SST} −29.3172)\hat{ }2) | 0.9915 | 0.0001 |
| 0°-5°N [symbol] 140°-145°E | Y=EXP(−3.5777 * (X_{SST} −29.4581)\hat{ }2) | 0.9982 | 0.0001 |
| 0°-5°N [symbol] 145°-150°E | Y=EXP(−3.0178 * (X_{SST} −29.3616)\hat{ }2) | 0.9949 | 0.0001 |
| 0°-5°N [symbol] 150°-155°E | Y=EXP(−5.4220 * (X_{SST} −29.4818)\hat{ }2) | 0.9926 | 0.0001 |
| 0°-5°N [symbol] 155°-160°E | Y=EXP(−4.2629 * (X_{SST} −29.4214)\hat{ }2) | 0.9746 | 0.0001 |
| 0°-5°N [symbol] 160°-165°E | Y=EXP(−1.8096 * (X_{SST} −29.2157)\hat{ }2) | 0.9763 | 0.0001 |
| 0°-5°N [symbol] 165°-170°E | Y=EXP(−0.9017 * (X_{SST} −28.9556)\hat{ }2) | 0.9375 | 0.0002 |
| 0°-5°N [symbol] 170°-175°E | Y=EXP(−1.3720 * (X_{SST} 28.9761)\hat{ }2) | 0.9151 | 0.0005 |
| 0°-5°N [symbol] 175°-180°E | Y=EXP(−0.9960 * (X_{SST} 28.8531)\hat{ }2) | 0.972 | 0.0001 |
| 0°-5°S [symbol] 125°-130°E | Y=EXP(−0.9418 * (X_{SST} −28.9547)\hat{ }2) | 0.8733 | 0.0021 |
| 0°-5°S [symbol] 130°-135°E | Y=EXP(−1.0022 * (X_{SST} −29.0060)\hat{ }2) | 0.8658 | 0.0025 |
| 0°-5°S [symbol] 135°-140°E | Y=EXP(−2.4252 * (X_{SST} −29.2177)\hat{ }2) | 0.9911 | 0.0001 |
| 0°-5°S [symbol] 140°-145°E | Y=EXP(−2.1608 * (X_{SST} −29.3482)\hat{ }2) | 0.9974 | 0.0001 |
| 0°-5°S [symbol] 145°-150°E | Y=EXP(−1.9407 * (X_{SST} −29.3892)\hat{ }2) | 0.9872 | 0.0001 |
| 0°-5°S [symbol] 150°-155°E | Y=EXP(−2.3564 * (X_{SST} −29.5865)\hat{ }2) | 0.9957 | 0.0001 |
| 0°-5°S [symbol] 155°-160°E | Y=EXP(−1.7244 * (X_{SST} −29.5416)\hat{ }2) | 0.9944 | 0.0001 |
| 0°-5°S [symbol] 160°-165°E | Y=EXP(−1.3631 * (X_{SST} −29.3466)\hat{ }2) | 0.9931 | 0.0001 |
| 0°-5°S [symbol] 165°-170°E | Y=EXP(−1.3044 * (X_{SST} −29.1658)\hat{ }2) | 0.996 | 0.0001 |
| 0°-5°S [symbol] 170°-175°E | Y=EXP(−1.1302 * (X_{SST} −29.2428)\hat{ }2) | 0.9566 | 0.0001 |
| 0°-5°S [symbol] 175°-180°E | Y=EXP(−2.8965 * (X_{SST} −29.4323)\hat{ }2) | 0.8971 | 0.0001 |

In the table, Y represents the percentage of the number of nets, and X_{SST} represents a temperature interval corresponding to SST

The verification of the fishing access prediction model: the SSTA of the Nino3.4 area in 2011 and 2012 and the SST of the operation waters are respectively substituted into the fishing access prediction model to obtain predicted values of the percentages of the number of nets, and the predicted values are compared with the actual values. The results show that there is a significant relationship between the two-year prediction results and the actual statistical values (P is less than 0.01) (Table 3).

TABLE 3
Regression equation of predicted value and actual value

| Forecast factor | Year | Regression equation | P |
|---|---|---|---|
| Nino3.area | 2011 | Y = 1.1979X − 0.8996 | P < 0.01 |
| SSTA | 2012 | Y = 0.9391X + 0.2767 | P < 0.01 |
| SST of | 2011 | Y = 1.0248X − 0.1126 | P < 0.01 |
| operation | 2012 | Y = 1.1613X − 0.7333 | P < 0.01 |
| waters | | | |

In the table, X represents the actual percentage of the number of nets, and Y represents the predicted percentage of the number of nets

It can be seen from the predicted results and the actual forecast results that, the first places are consistent (Table 4, Table 5). In the top three, two predicted values in 2011 and 2012 are the same as the actual values. In the top five, four predicted values in 2011 and 2012 are the same as the actual values. In the top ten, 9 and 8 predicted values in 2011 and 2012 are the same as the actual values respectively. Generally speaking, the predicted values are strongly consistent with the actual results, and the overall forecast accuracy is higher than 80%.

TABLE 4
Comparison of actual forecast and prediction and forecast results in 2011 (the
percentage of the number of nets is contained in parentheses)

| | | Prediction value based on | Prediction value based on |
|---|---|---|---|
| Rank | Actual percentage (top ten) | SSTA of NINO3.4 area | SST of operation waters |
| 1 | 0°-5°N [symbol] 130°-135°E | 0°-5°N [symbol] 130°-135°E | 0°-5°N [symbol] 130°-135°E |
| | (13.58%) | (22.19%) | (20.63%) |
| 2 | 0°-5° [symbol] 145°-150°E | 0°-5°N [symbol] 135°-140°E | 0°-5°N [symbol] 135°-140°E |
| | (10.02%) | (19.62%) | (17.01%) |
| 3 | 0°-5° [symbol] 135°-140°E | 0°-5°S [symbol] 135°-140°E | 0°-5°S [symbol] 135°-140°E |
| | (9.72%) | (10.96%) | (7.60%) |
| 4 | 0°-5° [symbol] 155°-160°E | 0°-5°N [symbol] 125°-130°E | 0°-5°S [symbol] 155°-160°E |
| | (8.77%) | (5.51%) | (6.71%) |
| 5 | 0°-5°N [symbol] 135°-140°E | 0°-5° [symbol] 155°-160°E | 0°-5°N [symbol] 150°-155°E |
| | (7.90%) | (4.88%) | (4.43%) |
| 6 | 0°-5° [symbol] 150°-155°E | 0°-5° [symbol] 125°-130°E | 0°-5°N [symbol] 125°-130°E |
| | (7.50%) | (4.44%) | (4.43%) |
| 7 | 0°-5°N [symbol] 125°-130°E | 0°-5° [symbol] 130°-135°E | 0°-5°N [symbol] 155°-160°E |
| | (6.63%) | (4.36%) | (4.42%) |
| 8 | 0°-5°N [symbol] 150°-155°E | 0°-5° [symbol] 150°-155°E | 0°-5°S [symbol] 160°-165°E |
| | (4.57%) | (3.72%) | (4.03%) |
| 9 | 0°-5°S [symbol] 140°-145°E | 0°-5° [symbol] 145°-150°E | 0°-5°S [symbol] 150°-155°E |
| | (4.44%) | (3.70%) | (4.00%) |
| 10 | 0°-5° [symbol] 165°-170°E | 0°-5° [symbol] 160°-165°E | 0°-5°S [symbol] 145°-150°E |
| | (4.11%) | (3.31%) | (3.37%) |

TABLE 5
Comparison of actual forecast and prediction and forecast results in 2012 (the
percentage of the number of nets is contained in parentheses)

| | | Prediction value based on | Prediction value based on |
|---|---|---|---|
| Rank | Actual percentage (top ten) | SSTA of NINO3.4 area | SST of operation waters |
| 1 | 0°-5°N [symbol] 130°-135°E | 0°-5°N [symbol] 130°-135°E (17.74%) | 0°-5°N [symbol] , 130°-135°E |
| | (11.35%) | | (21.92%) |
| 2 | 0°-5°S [symbol] 145°-150°E | 0°-5°N [symbol] 135°-140°E | 0°-5°N [symbol] 135°-140°E |
| | (10.58%) | (16.10%) | (17.33%) |
| 3 | 0°-5°S [symbol] 135°-140°E | 0°-5°S [symbol] 135°-140°E | 0°-5°S [symbol] 135°-140°E |
| | (8.08%) | (8.81%) | (8.24%) |
| 4 | 0°-5°N [symbol] 135°-140°E | 0°-5°S [symbol] 145°-150°E | 0°-5°S [symbol] 155°-160°E |
| | (6.58%) | (5.00%) | (5.27%) |
| 5 | 0°-5°S [symbol] 150°-155°E | 0°-5°S [symbol] 155°-160°E | 0°-5°S [symbol] 145°-150°E |
| | (6.49%) | (4.89%) | (4.50%) |
| 6 | 0°-5°S [symbol] 175°-180°E | 0°-5°N [symbol] 125°-130°E | 0°-5°N [symbol] 150°-155°E |
| | (6.32%) | (4.48%) | (4.49%) |
| 7 | 0°-5°S [symbol] 170°-175°E | 0°-5°S [symbol] 150°-155°E | 0°-5°S [symbol] 150°-155°E |
| | (5.82%) | (3.80%) | (4.40%) |
| 8 | 0°-5°S [symbol] 140°-145°E | 0°-5°S [symbol] 140°-145°E | 0°-5°N [symbol] 125°-130°E |
| | (5.80%) | (3.37%) | (4.28%) |
| 9 | 0°-5°N [symbol] 145°-150°E | 0°-5°N [symbol] 155°-160°E | 0°-5°N [symbol] 140°-145°E |
| | (5.53%) | (3.63%) | (3.81%) |
| 10 | 0°-5°N [symbol] 150°-155°E | 0°-5°S [symbol] 125°-130°E | 0°-5°S [symbol] 140°-145°E |
| | (5.03%) | (3.54%) | (3.78%) |

According to the production data of the Katsuwonuspelamis purse seine fishery in the Central and Western Pacific in 1995-2012, the variation law of the fishing effort in the spatial distribution is analyzed, the relationship between the fishing effort and the SSTA of the Nino 3.4 area and SST of the operation waters is established at the same time, the spatial and temporal distribution probability of the Katsuwonuspelamis resources in different marine environments is expressed in the form of a normal model, a basis is provided for the scientific fishing access of the Katsuwonuspelamis purse seine fishery in the Central and Western Pacific, the blindness of fishing is greatly reduced, and the fishing efficiency is improved.

What is claimed is:

1. A method for predicting fishing access of Katsuwonuspelamis purse seine fishery in the Central and Western Pacific, wherein production statistical data and corresponding environmental data within a plurality of years of sea areas are utilized, and the method comprises the following steps:
step 1, performing an initial value processing of the fishing effort of operation waters; calculating a percentage
$${N}_{i , j} = \frac{{X}_{i , j}}{{X}_{j}}$$
occupied by different sea surface temperature anomaly (SSTA) ranges of Nino3.4 area corresponding to each sea area by using a spacing 0.5° C. of the SSTA of the Nino3.4 area and sea surface temperature (SST) of the operation waters, and then dividing the percentage by a maximum ratio in the sea area to obtain
$$\overline{{N}_{i , j}} = \frac{{N}_{i , j}}{max {N}_{i , j}} ,$$
wherein Xⱼ represents the total amount of fishing effort in the j sea area, X_{i,j} represents the fishing effort within the i temperature range in the j sea area, N_{i,j} represents the percentage of the fishing effort within the i temperature range in the j sea area; maxN_{i,j} represents the maximum value of the percentage of the fishing effort within the i temperature range in the j sea area; and N̅_̅{̅i̅,̅j̅}̅ represents a ratio of the percentage of the fishing effort within the i temperature range in the j sea area to the maximum value of the percentage;
step 2, performing one by one matching processing on the production statistical data of each sea area of the operation waters and the corresponding environmental data, and respectively performing statistics on a relationship between different SSTA and SST ranges of each sea area and the corresponding initial value fishing effort; and
step 3, establishing a fishing access prediction model of each sea area based on the fishing access prediction model of the SSTA of NINO3.4 area and the fishing access prediction model of the SST of the operation waters, wherein the fishing access prediction model is expressed by a percentage of the fishing effort.

2. The method for predicting the fishing access of the Katsuwonuspelamis purse seine fishery in the Central and Western Pacific according to claim 1, wherein the operation waters are water of 5°S-5°N, 125°E-180°E, a sea area is denoted by 5°×5° spatial resolution, and the operation waters is divided into 22 sea areas.

3. The method for predicting the fishing access of the Katsuwonuspelamis purse seine fishery in the Central and Western Pacific according to claim 1, wherein by adoption of the fishing access prediction model of each sea area based on the fishing access prediction model of the SSTA of NINO3.4 area and the fishing access prediction model of the SST of the operation waters obtained in the step 3, performing a prediction of the fishing access of the Katsuwonuspelamis on the sea area to obtain a predicted value of the percentage of the fishing effort of the sea area.

4. The method for predicting the fishing access of the Katsuwonuspelamis purse seine fishery in the Central and Western Pacific according to claim 3, further comprising: according to the fishing access prediction result of the Katsuwonuspelamis of each sea area, arranging the sea areas according to the sizes of the predicted values of the percentage of the fishing effort of the sea areas, and recommending the preceding sea areas to perform the purse seine fishery.

5. The method for predicting the fishing access of the Katsuwonuspelamis purse seine fishery in the Central and Western Pacific according to claim 2, wherein by adoption of the fishing access prediction model of each sea area based on the fishing access prediction model of the SSTA of NINO3.4 area and the fishing access prediction model of the SST of the operation waters obtained in the step 3, performing a prediction of the fishing access of the Katsuwonuspelamis on the sea area to obtain a predicted value of the percentage of the fishing effort of the sea area.

6. The method for predicting the fishing access of the Katsuwonuspelamis purse seine fishery in the Central and Western Pacific according to claim 5, further comprising: according to the fishing access prediction result of the Katsuwonuspelamis of each sea area, arranging the sea areas according to the sizes of the predicted values of the percentage of the fishing effort of the sea areas, and recommending the preceding sea areas to perform the purse seine fishery.
